(19) United States
(12) Patent Application Publication
(10) Pub. No.: US 2025/0045594 A1
(43) Pub. Date: Feb. 6, 2025

(54) ENERGY STORAGE SYSTEM, AND THERMAL MANAGEMENT METHOD FOR ENERGY STORAGE SYSTEM

(71) Applicant: Sungrow Energy Storage Technology Co., Ltd., Hefei (CN)

(72) Inventors: Zihao Zhao, Hefei (CN); Jianjie Zhou, Hefei (CN); Tingting Hong, Hefei (CN); Xiaohui Cao, Hefei (CN); Fanglin Chen, Hefei (CN); Lulu Jiang, Hefei (CN)

(73) Assignee: Sungrow Energy Storage Technology Co., Ltd., Hefei (CN)

(21) Appl. No.: 18/649,022

(22) Filed: Apr. 29, 2024

(30) Foreign Application Priority Data
Jul. 31, 2023 (CN) 202310966705.8

(51) Int. Cl. G06N 3/092; F25B 29/00; H01M 10/613; H01M 10/633; H01M 10/6554; H01M 10/6569

(52) U.S. Cl. CPC G06N 3/092; F25B 29/003; H01M 10/613; H01M 10/633; H01M 10/6554; H01M 10/6569

(57) ABSTRACT

An energy storage system and a thermal management method therefor are provided. The method includes: loading a multi-agent reinforcement learning model pre-trained and optimized through a simulation environment; receiving state observation data at a current time instant; inputting the state observation data into the multi-agent reinforcement learning model for reinforcement learning and reasoning to output multi-control action information; and generating a control action information instruction based on the multi-control action information, transmitting the control action information instruction to a cooling system in the energy storage system, and performing by the cooling system, thermal management on the energy storage system in response to the control action information instruction.

The present application claims priority to Chinese Patent Application No. 202310966705.8, titled “ENERGY STORAGE SYSTEM, AND THERMAL MANAGEMENT METHOD FOR ENERGY STORAGE SYSTEM”, filed on Jul. 31, 2023 with the China National Intellectual Property Administration, which is incorporated herein by reference in its entirety.

### FIELD

The present disclosure relates to the technical field of energy storage, and in particular to an energy storage system and a thermal management method for the energy storage system.

### BACKGROUND

With the continuous development of electrochemical energy storage technology, electrochemical energy storage has an increasing proportion in global renewable energy distribution and storage. An important development trend is to provide a lithium battery energy storage system which has a large capacity and is highly integrated. There are increasingly high requirements for safety and temperature consistency of the battery. Correspondingly, power consumption of a cooling system is increasing. Therefore, thermal management is necessary.

In the thermal management method according to the conventional technology, a control system for a liquid cooling unit in a cooling system regulates a control mode based on a difference between a temperature of a coolant and a temperature of a battery box. In addition, the control mode is regulated progressively based on a temperature range of the battery box, in order to reduce power consumption and a temperature difference inside the battery box.

In the conventional thermal management method, a temperature is set based on human experience, which is prone to cause a temperature hysteresis effect during the thermal management, making it difficult to flexibly control heat generation and dissipation of the battery box based on an objective condition.

### SUMMARY

In view of this, an energy storage system and a thermal management method for the energy storage system are provided according to embodiments of the present disclosure, in order to reduce an impact of a temperature hysteresis effect generated during the thermal management and flexibly control the thermal management system.

In order to achieve the above objectives, the following technical solutions are provided according to the embodiments of the present disclosure.

A thermal management method for an energy storage system is provided according to a first aspect of the embodiments of the present disclosure. The thermal management method is applied to an intelligent battery thermal management unit in the energy storage system. The thermal management method includes:
loading a multi-agent reinforcement learning model pre-trained and optimized through a simulation environment;
receiving state observation data at a current time instant;
inputting the state observation data into the multi-agent reinforcement learning model for reinforcement learning and reasoning to output multi-control action information; and
generating a control action information instruction based on the multi-control action information, transmitting the control action information instruction to a cooling system in the energy storage system, and performing by the cooling system, thermal management on the energy storage system in response to the control action information instruction.

In an embodiment, after the receiving state observation data at a current time instant the thermal management method further includes:
determining an observation time step of the state observation data;
determining whether the observation time step reaches a preset length;
acquiring historical observation data, iteratively training the multi-agent reinforcement learning model by using the historical observation data and updating a parameter of the multi-agent reinforcement learning model in a case that the observation time step reaches the preset length, or, continuing to the process of receiving state observation data at a current time instant in a case that the observation time step does not reach the preset length.

In an embodiment, the performing by the cooling system, thermal management on the energy storage system includes: performing, by the cooling system, the thermal management on a battery system in the energy storage system; or performing, by the cooling system, the thermal management on a battery system and an electric energy conversion unit in the energy storage system.

In an embodiment, the multi-agent reinforcement learning model is pre-trained and optimized by:
acquiring a state parameter and a control parameter of the energy storage system;
determining a state observation space, an action space, a constraint space and a reward function of the multi-agent reinforcement learning model based on the state parameter and the control parameter;
constructing the multi-agent reinforcement learning model based on the state observation space, the action space, the constraint space and the reward function;
receiving state observation data at a time instant t, inputting the state observation data into the multi-agent reinforcement learning model for training, to output an action a(t+1), a reward r(t) and a state s(t+1) at a time instant t+1;
calculating a state value function and a dominance function based on the action a(t+1), the reward r(t) and the state s(t+1);
storing, in a data buffer pool, a sequence formed by the action a(t+1), the reward r(t), the state s(t+1), the state value function and the dominance function;
sampling N sequences randomly from the data buffer pool as training data, where N is a positive integer;
calculating, based on the sampled batch of sequences, a parameter gradient of a neural network in the multi-agent reinforcement learning model; and
updating a parameter of the neural network in the multi-agent reinforcement learning model by using the parameter gradient of the neural network.

In an embodiment, the thermal management method further includes:
storing, in the data buffer pool, a sequence formed by a current state, a current action, a current reward, a next state, the state value function and the dominance function; and
selecting a preset quantity of batch of sequences randomly to train the multi-agent reinforcement learning model, and updating the neural network in the multi-agent reinforcement learning model by using the state observation data, until the multi-agent reinforcement learning model converges.

In an embodiment, the acquiring a state parameter and a control parameter of the energy storage system includes:
acquiring, via an energy management system (EMS) in the energy storage system, a charging-discharging current and an ambient temperature of a battery system in the energy storage system in a current time period, and a charging-discharging current and an ambient temperature of the battery system in the energy storage system in a next time period;
acquiring a current cell state parameter of the battery system and power consumption of various components and a refrigerant returning temperature of the cooling system in the energy storage system, where the current cell state parameter includes a current cell temperature and a current state of charge (SOC); and
acquiring a control parameter of the cooling system, where the control parameter includes a control mode of the cooling system, a rotation speed of a water pump and a coolant outlet temperature.

An energy storage system is provided according to a second aspect of the embodiments of the present disclosure. The energy storage system includes a cooling system, a battery system, an electric energy conversion unit, an energy management system (EMS), and an intelligent battery thermal management unit. The EMS is communicatively connected to the electric energy conversion unit via an end of the EMS and is communicatively connected to a downstream device of the energy storage system via another end of the EMS, and is configured to receive a predicted power transmitted from the downstream device, and determine a charging-discharging current of the battery system in a next preset time period based on the predicted power, and the predicted power includes a predicted electricity generation power and a predicted load power. The intelligent battery thermal management unit is communicatively connected to the cooling system, the electric energy conversion unit, the EMS and a weather system, and the intelligent battery thermal management unit is configured to perform the thermal management method for an energy storage system according to the first aspect of the present disclosure.

In an embodiment, the electric energy conversion unit includes a direct current (DC)-alternating current (AC) unit and multiple DC-DC units. A direct current side of the DC-AC unit is connected to the multiple DC-DC units via a direct current bus. The DC-AC unit is communicatively connected to the EMS via a communication side of the DC-AC unit. The multiple DC-DC units each are communicatively connected to the intelligent battery thermal management unit.

In an embodiment, the cooling system is a coolant system and is configured to perform thermal management on the battery system, the cooling system includes a cell liquid cooling plate, a plate heat exchanger, a compressor, a condenser, an air-water exchanger, a first heater, a first circulation pump and a first electromagnetic three-way valve. A first end of the cell liquid cooling plate is connected to a first input end of the plate heat exchanger, and a first output end of the plate heat exchanger is connected to a first end of the first electromagnetic three-way valve. A second end of the first electromagnetic three-way valve is connected to a second end of the cell liquid cooling plate through the first circulation pump and the first heater sequentially. A third end of the first electromagnetic three-way valve is connected to a second end of the air-water exchanger, and a first end of the air-water exchanger is connected to the first input end of the plate heat exchanger. A second output end of the plate heat exchanger is connected to a second input end of the plate heat exchanger through the condenser and the compressor sequentially.

In an embodiment, in an internal circulation of a coolant, the coolant flows through the cell liquid cooling plate, the plate heat exchanger, the first electromagnetic three-way valve, the first circulation pump and the first heater; in an external circulation of a coolant, the coolant flows through the cell liquid cooling plate, the air-water exchanger, the first electromagnetic three-way valve, the first circulation pump and the first heater; and in a circulation of a cooling agent, the cooling agent flows through the plate heat exchanger, the compressor and the condenser.

In an embodiment, the intelligent battery thermal management unit is configured to control the cooling system to perform thermal management on the energy storage system by: opening the first end and the second end of the first electromagnetic three-way valve, to control the battery system to be in the internal circulation of the coolant, and controlling an operating frequency of the first circulation pump; or opening the third end and the second end of the first electromagnetic three-way valve, to control the battery system to be in the external circulation of the coolant, and controlling the operating frequency of the first circulation pump; controlling the first heater to be started or stopped; and controlling the first circulation pump and the compressor to be started or stopped, and controlling an operating frequency of the first circulation pump and an operating frequency of the compressor.

In an embodiment, the cooling system is further configured to perform thermal management on the electric energy conversion unit, and the cooling system further includes a second heater, a second circulation pump and a second electromagnetic three-way valve. A third end of the air-water exchanger is connected to a first end of the second electromagnetic three-way valve and a first end of the electric energy conversion unit. A fourth end of the air-water exchanger is connected to a second end of the second electromagnetic three-way valve. A third end of the second electromagnetic three-way valve is connected to a second end of the electric energy conversion unit through the second circulation pump and the second heater sequentially.

In an embodiment, the cooling system is configured to perform thermal management on the electric energy conversion unit through an internal circulation of a coolant, in the internal circulation of the coolant, the coolant flows through the second electromagnetic three-way valve, the second circulation pump, the second heater and the electric energy conversion unit. The cooling system is configured to perform thermal management on the electric energy conversion unit through an external circulation of a coolant. In the external circulation of the coolant, the coolant flows through the air-water exchanger, the second electromagnetic three-way valve, the second circulation pump, the second heater and the electric energy conversion unit.

An energy storage system and a thermal management method for the energy storage system are provided according to the embodiments of the present disclosure. The thermal management method includes: loading a multi-agent reinforcement learning model pre-trained and optimized through a simulation environment; receiving state observation data at a current time instant; inputting the state observation data into the multi-agent reinforcement learning model for reinforcement learning and reasoning to output multi-control action information; and generating a control action information instruction based on the multi-control action information, transmitting the control action information instruction to a cooling system in the energy storage system, and performing by the cooling system, thermal management on the energy storage system in response to the control action information instruction. In the solution, after the multi-agent reinforcement learning model is loaded, the reinforcement learning and reasoning is performed on the received state observation data by using the multi-agent reinforcement learning model, and the control action information instruction is generated based on the acquired multi-control action information and is transmitted to the cooling system in the energy storage system, so that the cooling system performs the thermal management on the energy storage system in response to the control action information instruction, thereby reducing the impact of the temperature hysteresis effect generated during the thermal management, and flexibly controlling the thermal management system.

### BRIEF DESCRIPTION OF THE DRAWINGS

In order to more clearly illustrate technical solutions in embodiments of the present disclosure or in the conventional technology, the drawings to be used in the description of the embodiments or the conventional technology are briefly described below. Apparently, the drawings in the following description show only some embodiments of the present disclosure, and other drawings may be obtained by those skilled in the art from the drawings without any creative work.

FIG. 1 is a flowchart of a thermal management method for an energy storage system according to an embodiment of the present disclosure;

FIG. 2 is a flowchart of pre-training and optimizing a multi-agent reinforcement learning model according to an embodiment of the present disclosure;

FIG. 3 is a schematic structural diagram of an energy storage system according to an embodiment of the present disclosure;

FIG. 4 is a schematic diagram of a cooling circulation of a cooling system in an energy storage system according to an embodiment of the present disclosure; and

FIG. 5 is a schematic diagram of a cooling circulation of a cooling system in an energy storage system according to another embodiment of the present disclosure.

### DETAILED DESCRIPTION

The technical solutions in the embodiments of the present disclosure are described clearly and completely in conjunction with the drawings in the embodiments of the present disclosure hereinafter. It is apparent that the described embodiments are only some rather than all embodiments of the present disclosure. All other embodiments obtained by those skilled in the art based on the embodiments of the present disclosure without any creative work fall within the protection scope of the present disclosure.

In the present disclosure, terms of “include”, “comprise” or any other variants are intended to be non-exclusive. Therefore, a process, method, article or device including a series of elements includes not only the elements but also other elements that are not enumerated, or further includes the elements inherent for the process, method, article or device. Unless expressively limited otherwise, the statement “comprising (including) one . . . ” does not exclude existence of other similar elements in the process, method, article or device.

As described in the background, in the conventional thermal management method, a temperature is set based on human experience, which is prone to cause a temperature hysteresis effect during the thermal management, making it difficult to flexibly control heat generation and dissipation of the battery box based on an objective condition.

Hence, an energy storage system and a thermal management method for the energy storage system are provided according to the embodiments of the present disclosure. In the solution, after a multi-agent reinforcement learning model is loaded, reinforcement learning and reasoning is performed on received state observation data by using the multi-agent reinforcement learning model, and a control action information instruction is generated based on acquired multi-control action information and is transmitted to a cooling system in the energy storage system, so that the cooling system performs the thermal management on the energy storage system in response to the control action information instruction, thereby reducing the impact of the temperature hysteresis effect generated during the thermal management, and flexibly controlling the thermal management system.

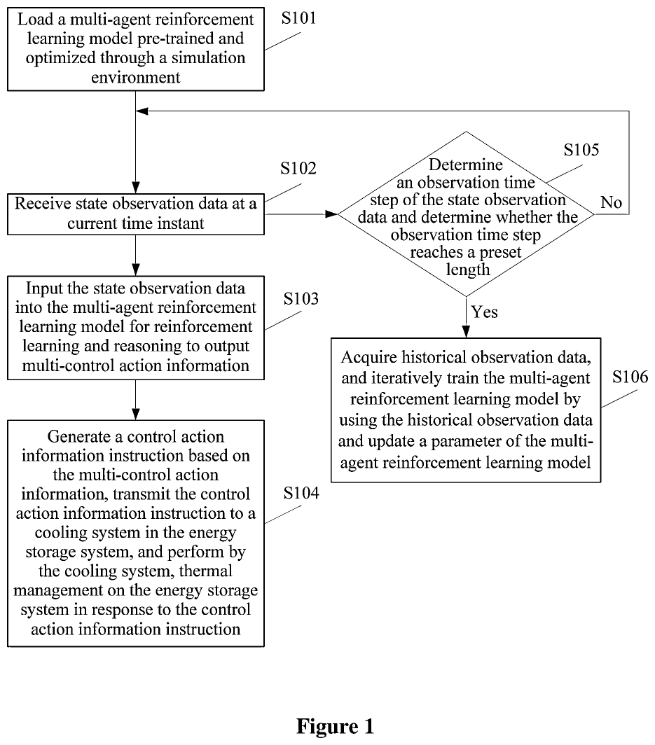

Reference is made to FIG. 1, which is a flowchart of a thermal management method for an energy storage system according to an embodiment of the present disclosure.

It should be noted that the thermal management method for an energy storage system is applied to the energy storage system. Specifically, an intelligent battery thermal management unit in the energy storage system performs the thermal management method through executing a control instruction.

The thermal management method for an energy storage system mainly includes the following steps S101 to S106.

In step S101, a multi-agent reinforcement learning model pre-trained and optimized through a simulation environment is loaded.

It should be noted that the simulation environment is a simulation model for a battery system. The simulation model may serve as an interactive environment for reinforcement learning, and is used to train the multi-agent reinforcement learning model by using a large amount of simulation data.

It should be further noted that in the embodiment of the present disclosure, the multi-agent reinforcement learning model includes but is not limited to a reinforcement learning model controlled by a single agent and a reinforcement learning model controlled by multiple agents, and details are described in step S103.

In an implementation of step S101, the intelligent battery thermal management unit loads an application scenario of the energy storage system and the multi-agent reinforcement learning model pre-trained and optimized through the simulation environment.

In some embodiments, after the multi-agent reinforcement learning model trained and optimized through the simulation environment is loaded, in a case that a current application scenario of the energy storage system is the same as a trained scenario in the multi-agent reinforcement learning model, it indicates that thermal management may be currently performed on the energy storage system based on subsequently received real-time observation data by using the trained and optimized multi-agent reinforcement learning model, and the process proceeds to step S102.

In a case that a current application scenario of the energy storage system is different from trained scenarios in the multi-agent reinforcement learning model, it indicates that the application scenario of the energy storage system is not trained through the multi-agent reinforcement learning model, thermal management cannot be performed on the energy storage system based on subsequently received real-time observation data, and the process proceeds to step S105.

It should be noted that the pre-trained and optimized multi-agent reinforcement learning model serves as a control unit in the energy storage system, and is used to execute the control instruction. In other words, the multi-agent reinforcement learning model is applied to the intelligent battery thermal management unit.

In step S102, state observation data at a current time instant is received.

The current time instant in step S102 may be a time instant t.

In an implementation of step S102, after the multi-agent reinforcement learning model trained and optimized through the simulation environment is loaded, the intelligent battery thermal management unit receives the state observation data at the current time instant, so that thermal management can be performed on the energy storage system based on the subsequently received state observation data by using the trained and optimized multi-agent reinforcement learning model.

In step S103, the state observation data is inputted into the multi-agent reinforcement learning model for reinforcement learning and reasoning to output multi-control action information.

The multi-control action information in step S103 includes but is not limited to a control mode of a liquid cooling system, a rotation speed of a water pump, and a water outlet temperature.

In an implementation of step S103, the state observation data serves as an input of the multi-agent reinforcement learning model, is inputted into the multi-agent reinforcement learning model, and the multi-agent reinforcement learning model performs reinforcement learning by using the state observation data, to output the multi-control action information. In practice, the control mode of the liquid cooling system, the rotation speed of the water pump, the water outlet temperature and other information are outputted.

It should be noted that the state observation data may be inputted, in a combination manner, into a single-agent reinforcement learning model (such as deep deterministic policy gradient (DDPG), proximal policy optimization (PPO), or asynchronous advantage actor-critic (A3C)) for reinforcement learning and reasoning, to output one piece of multi-control action information.

The single-agent reinforcement learning model is controlled by a single agent.

The state observation data may include several parts, and several parts are separately inputted into the multi-agent reinforcement learning model (such as multi-agent deep deterministic policy gradient (MADDPG), multi-agent PPO (MAPPO), or counterfactual multi-agent policy gradients (COMA)) for reinforcement learning and reasoning, to output multiple pieces of multi-control action information. The multiple pieces of multi-control action information are combined to obtain final control action information.

The multi-agent reinforcement learning model is controlled by multiple agents.

In step S104, a control action information instruction is generated based on the multi-control action information, the control action information instruction is transmitted to the cooling system in the energy storage system, and the cooling system is configured to perform thermal management on the energy storage system in response to the control action information instruction.

In an implementation of step S104, the control action information instruction is generated based on the multi-control action information, the control action information instruction is transmitted to the cooling system in the energy storage system, and the cooling system performs the thermal management on the energy storage system in response to the control action information instruction.

In some embodiments, the cooling system performs the thermal management on the battery system in the energy storage system. Alternatively, the cooling system performs the thermal management on the battery system and an electric energy conversion unit in the energy storage system.

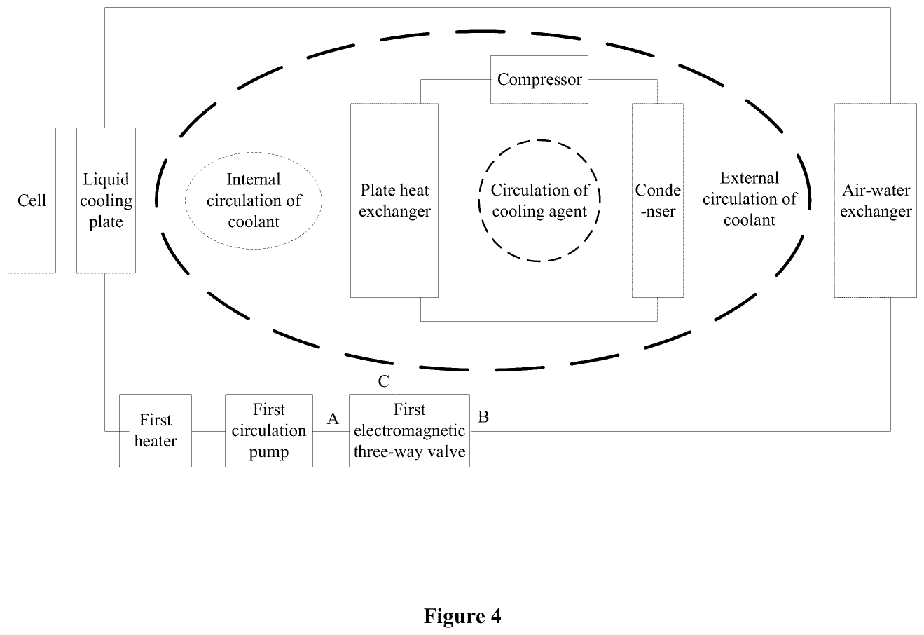

As shown in FIG. 4, in a case that the cooling system is a coolant system and performs the thermal management only on the battery system, the cooling system may perform the thermal management through the following manners.

The cooling system is configured to perform the thermal management on the battery system in the energy storage system through an internal circulation of a coolant. Specifically, in the internal circulation of the coolant, the cooling system performs the thermal management through a cell liquid cooling plate, a plate heat exchanger, a first electromagnetic three-way valve, a first circulation pump, and a first heater. In other words, in the internal circulation of the coolant, the coolant in the cooling system flows through the cell liquid cooling plate, the plate heat exchanger, the first electromagnetic three-way valve, the first circulation pump, and the first heater, to realize the thermal management on the battery system in the energy storage system.

The cooling system is configured to perform the thermal management on the battery system in the energy storage system through an external circulation of a coolant. Specifically, in the external circulation of the coolant, the cooling system performs the thermal management through the cell liquid cooling plate, an air-water exchanger, the first electromagnetic three-way valve, the first circulation pump, and the first heater. In other words, in the external circulation of the coolant, the coolant in the cooling system flows through the cell liquid cooling plate, the air-water exchanger, the first electromagnetic three-way valve, the first circulation pump, and the first heater, to realize the thermal management on the battery system in the energy storage system.

The cooling system is configured to perform the thermal management on the battery system in the energy storage system through a circulation of a cooling agent. Specifically, in the circulation of the cooling agent, the cooling system performs the thermal management through the plate heat exchanger, a condenser, and a compressor. In other words, in the circulation of the cooling agent, the cooling agent in the cooling system flows through the plate heat exchanger, the condenser, and the compressor, to realize the thermal management on the battery system in the energy storage system.

With the thermal management method for the cooling system as described above, the thermal management on the battery system in the energy storage system specifically includes as follows.

1. The thermal management is performed on the battery system in the energy storage system only through the internal circulation of the coolant.

In practice, a first end C and a second end A of the first electromagnetic three-way valve are opened, to control the battery system to be in the internal circulation of the coolant, and an operating frequency of the first circulation pump is controlled, so as to realize the thermal management on the battery system in the energy storage system.

2. The thermal management is performed on the battery system in the energy storage system both through the internal circulation of the coolant and the first heater.

In practice, the first end C and the second end A of the first electromagnetic three-way valve are opened, to control the battery system to be in the internal circulation of the coolant, and the first heater is started, so as to realize the thermal management on the battery system in the energy storage system.

3. The thermal management is performed on the battery system in the energy storage system both through the internal circulation of the coolant and the circulation of the cooling agent.

In practice, the first end C and the second end A of the first electromagnetic three-way valve are opened, to control the battery system to be in the internal circulation of the coolant, the compressor and the first circulation pump are started, and an operating frequency of the compressor and an operating frequency of the first circulation pump are controlled, so as to realize the thermal management on the battery system in the energy storage system.

4. The thermal management is performed on the battery system in the energy storage system only through the external circulation of the coolant.

In practice, a third end B and the second end A of the first electromagnetic three-way valve are opened, to control the battery system to be in the external circulation of the coolant, and the operating frequency of the first circulation pump is controlled, so as to realize the thermal management on the battery system in the energy storage system.

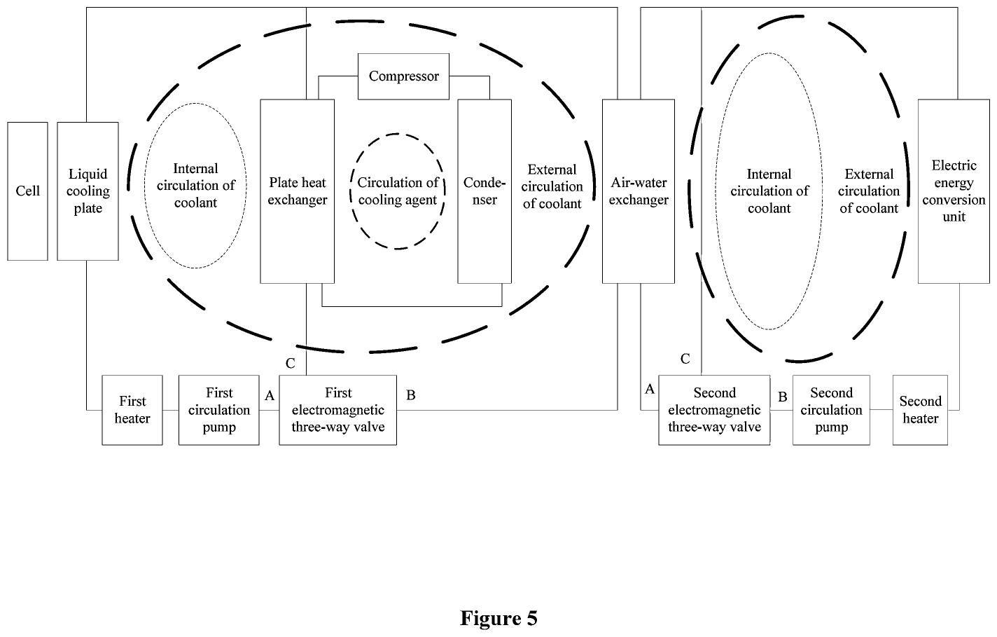

As shown in FIG. 5, in a case that the cooling system is a coolant system and performs the thermal management on both the battery system and the electric energy conversion unit in the energy storage system, the cooling system may perform the thermal management through the following manners.

The cooling system is configured to perform the thermal management on the electric energy conversion unit in the energy storage system through an internal circulation of a coolant. Specifically, in the internal circulation of the coolant, the cooling system performs the thermal management through a second electromagnetic three-way valve, a second circulation pump, a second heater and the electric energy conversion unit. In other words, in the internal circulation of the coolant, the coolant in the cooling system flows through the second electromagnetic three-way valve, the second circulation pump, the second heater and the electric energy conversion unit, to realize the thermal management on the electric energy conversion unit in the energy storage system.

The cooling system is configured to perform the thermal management on the electric energy conversion unit in the energy storage system through an external circulation of a coolant. Specifically, in the external circulation of the coolant, the cooling system performs the thermal management through an air-water exchanger, the second electromagnetic three-way valve, the second circulation pump, the second heater and the electric energy conversion unit. In other words, in the external circulation of the coolant, the coolant in the cooling system flows through the air-water exchanger, the second electromagnetic three-way valve, the second circulation pump, the second heater and the electric energy conversion unit, to realize the thermal management on the electric energy conversion unit in the energy storage system.

It should be noted that a process of performing the thermal management on the electric energy conversion unit is similar to the process of performing the thermal management on the battery system described above, and is not described in detail herein. Reference may be made to each other. All the implementations fall within the protection scope of the present disclosure.

In step S105, an observation time step of the state observation data is determined and it is determined whether the observation time step reaches a preset length. The process proceeds to step S106 in a case that the observation time step reaches the preset length, and the process proceeds to step S102 in a case that the observation time step does not reach the preset length.

A specific value of the preset length in step S105 is determined based on an actual training situation of the model, and is not limited in the present disclosure. All the implementations fall within the protection scope of the present disclosure.

In some embodiments, the observation time step is 1 day or 2 days.

In an implementation of step S105, after the state observation data is received, the observation time step of the state observation data is determined, and the observation time step is compared with the preset length. In a case that the observation time step is greater than or equal to the preset length, it indicates that the observation time step reaches the preset length and the multi-agent reinforcement learning model is to be optimized, and the process proceeds to step S106. In a case that the observation time step is less than the preset length, it indicates that the observation time step does not reach the preset length and the multi-agent reinforcement learning model is not to be optimized, and the process proceeds to step S102.

It should be noted that when a certain amount (such as one day or two days) of the observation data is received, the multi-agent reinforcement learning model is optimized and a parameter of the multi-agent reinforcement learning model is modified.

In step S106, historical observation data is acquired, and the multi-agent reinforcement learning model is iteratively trained by using the historical observation data and a parameter of the multi-agent reinforcement learning model is updated.

In an implementation of step S106, in a case that the observation time step of the state observation data reaches the preset length, the historical observation data is acquired, and the multi-agent reinforcement learning model is iteratively trained by using the historical observation data. In practice, an online learning mode of a multi-agent reinforcement learning algorithm is activated, and the multi-agent reinforcement learning algorithm is iteratively trained according to a training strategy described below. Then, the parameter of the multi-agent reinforcement learning model is updated.

From the above description, it can be understood that a simulation model of the battery system is constructed as an interaction environment for the reinforcement learning, and the multi-agent reinforcement learning model is trained by using a large amount of simulation data. Then, when a certain amount (such as one day or two days) of the observation data is received, the multi-agent reinforcement learning model is optimized and the parameter of the multi-agent reinforcement learning model is modified.

With the thermal management method for an energy storage system according to the embodiment of the present disclosure, after the multi-agent reinforcement learning model is loaded, reinforcement learning and reasoning is performed on the received state observation data by using the multi-agent reinforcement learning model, and the control action information instruction is generated based on acquired multi-control action information and is transmitted to the cooling system in the energy storage system, so that the cooling system performs the thermal management on the energy storage system in response to the control action information instruction, thereby reducing the impact of the temperature hysteresis effect generated during the thermal management, and flexibly controlling the thermal management system.

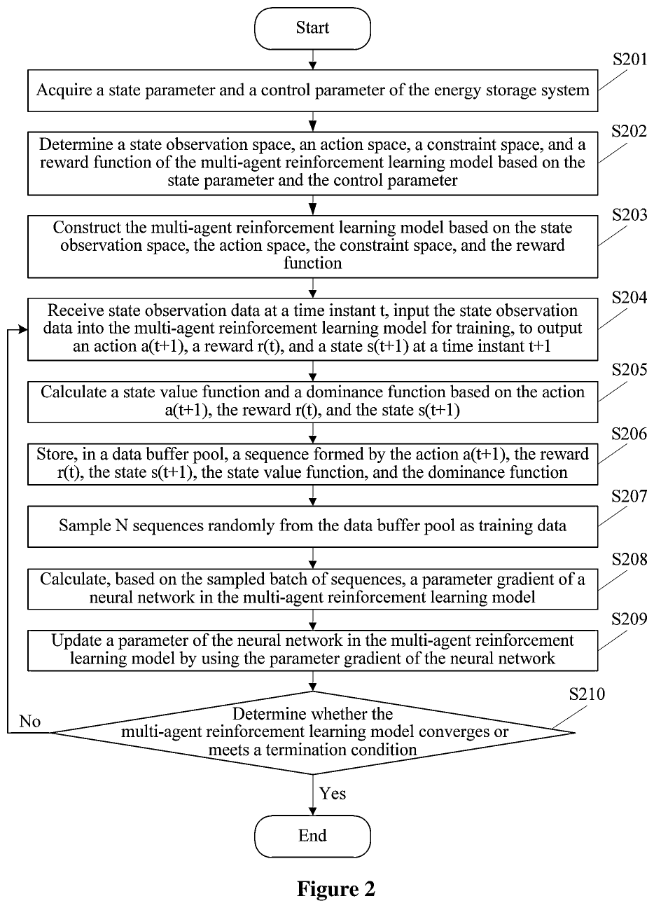

In an embodiment, reference is made to FIG. 2, which is a flowchart of a process of pre-training and optimizing a multi-agent reinforcement learning model according to an embodiment of the present disclosure. The multi-agent reinforcement learning model is pre-trained and optimized by the following steps S201 to S210.

In step S201, a state parameter and a control parameter of the energy storage system are acquired.

The state parameter in step S201 includes but is not limited to a state of a battery box in the energy storage system and power consumption of various components in the cooling system.

The state of the battery box includes but is not limited to a current cell state parameter, a charging-discharging current in a current time period, a charging-discharging current in a next time period, an ambient temperature in the current time period, and an ambient temperature in the next time period.

The current cell state parameter includes a current cell temperature and a current state of charge (SOC) of a battery.

The charging-discharging current includes a current when the battery system is being charged and a current when the battery system is discharging electricity. In a case that the charging-discharging current is equal to zero, the battery system is neither discharging electricity nor being charged. In a case that the charging-discharging current is not equal to zero, if the current when the battery system is being charged is defined as positive and the current when the battery system is discharging electricity is defined as negative, a positive charging-discharging current indicates that the battery system is being charged, and a negative charging-discharging current indicates that the battery system is discharging electricity.

It should be noted that a specific value of the time period may be determined based on an actual situation of the energy storage system, and is not limited in the present disclosure. All the implementations fall within the protection scope of the present disclosure.

In some embodiments, the time period may be a few minutes, a few tens of minutes, or a few hours.

The power consumption of various components in the cooling system includes but is not limited to a power consumption state of each component, a refrigerant returning temperature and a pressure state.

The control parameter includes but is not limited to a control mode of the cooling system, a rotation speed of a water pump, and a coolant outlet temperature.

The control mode includes but is not limited to a stopping mode, a cooling mode, a heating mode, and a pump circulation mode. The cooling mode is for the compressor, and the heating mode is for the heater.

In an implementation of step S201, the intelligent battery thermal management unit acquires, via an energy management system (EMS) in the energy storage system, the state of the battery box in the energy storage system, the power consumption of various components in the cooling system, and the control parameter of the cooling system.

In practice, the EMS in the energy storage system is communicatively connected to the intelligent battery thermal management unit. The intelligent battery thermal management unit acquires, via the EMS in the energy storage system, a charging-discharging current and an ambient temperature of the battery system in the energy storage system in a current time period, and a charging-discharging current and an ambient temperature of the battery system in the energy storage system in a next time period. In an embodiment, the EMS may receive a predicted power transmitted from a downstream device, and determine, based on the predicted power, the charging-discharging current of the battery system in the current time period and the charging-discharging current of the battery system in the next time period. Specifically, the EMS may receive a predicted generation power transmitted from a generation power prediction unit in a downstream power generation device and a predicted load power transmitted from a load power prediction unit in a downstream power consumption device, and determine, based on the predicted generation power and the predicted load power, the charging-discharging current in the current time period and the charging-discharging current in the next time period. The EMS may acquire the ambient temperature via a temperature sensor.

In practice, the current cell temperature and the current SOC of the battery in the battery system, the power consumption of various components of the cooling system in the energy storage system and the refrigerant returning temperature are acquired. In an embodiment, the current cell temperature is acquired via a temperature sensor, the SOC of the battery is detected via a detection device, and the power consumption of various components in the cooling system in the energy storage system and the refrigerant returning temperature are detected via a detection device.

It should be noted that the current cell temperature, the SOC of the battery, the power consumption of various components in the cooling system and the refrigerant returning temperature are further acquired in other manners and are not limited in the present disclosure. All the implementations fall within the protection scope of the present disclosure.

In an implementation, in a case that the cooling system is the coolant system, the refrigerant returning temperature is a temperature of a coolant flowing into a coolant device.

In practice, an inlet water temperature, a return water temperature and the pressure state of the cooling system in the energy storage system may further be acquired. The acquired state parameter of the energy storage system may be determined based on an actual situation of the energy storage system, which is not limited in the present disclosure. All the implementations fall within the protection scope of the present disclosure.

In practice, the control mode of the cooling system, the rotation speed of the water pump, the coolant outlet temperature and other control parameters are acquired. In an embodiment, the control mode of the cooling system, the rotation speed of the water pump, and the coolant outlet temperature are detected via a detection device.

It should be noted that the process of acquiring relevant parameters described above is to analyze important factors on heat generation of a lithium battery in the battery box, and a working mode, a cooling manner, and a controllable variable in the cooling mode, in order to establish an environmental model for the thermal management.

In step S202, a state observation space, an action space, a constraint space, and a reward function of the multi-agent reinforcement learning model are determined based on the state parameter and the control parameter.

The state observation space in step S202 includes but is not limited to a temperature of the battery box, operating power states of various component of a liquid cooling unit, the inlet water temperature, the return water temperature and the pressure state of the liquid cooling unit, the SOC of the battery, the ambient temperature, and the charging-discharging current.

The temperature of the battery box includes but is not limited to a range, a variance, an average, and change rate of temperature. The temperature of the battery box may be expressed as:

$$T = [ \begin{matrix}{T}_{1}^{max} & {T}_{2}^{max} & … & {T}_{k}^{max} \\ {T}_{1}^{min} & {T}_{2}^{min} & … & {T}_{k}^{min} \\ {T}_{1}^{a v g} & {T}_{2}^{a v g} & … & {T}_{k}^{a v g} \\ {RHF}_{1}^{max} & {RHF}_{2}^{max} & … & {RHF}_{k}^{max} \\ R H {F}_{1}^{min} & RH {F}_{2}^{min} & … & RH {F}_{k}^{min}\end{matrix} ] \qquad ( 1 )$$

In equation (1), Tᵢ^{max}, Tᵢ^{min}, Tᵢ^{avg}, RHFᵢ^{max} and RHFᵢ^{min} represent a maximum temperature, a minimum temperature, an average, a maximum temperature rise rate, and a minimum temperature rise rate of an i-th battery pack in the battery box, respectively, and k represents the number of battery packs in the battery box.

The operating power states of various component of the liquid cooling unit includes power states of the heater, the circulation pump, the plate heat exchanger, the compressor, the condenser, and the air-water exchanger in the liquid cooling unit, which may be expressed as:

$$P = [ {P}_{heater} , {P}_{circulation pump} , {P}_{heat exchanger} , {P}_{compressor} , {P}_{air - water exchanger} ] \qquad ( 2 )$$

The inlet water temperature, the return water temperature and the pressure state of the liquid cooling unit may be expressed as:

$$W = [ {T}_{i n} , {T}_{out} , {P}_{i n} , {P}_{out} ] \qquad ( 3 )$$

In equation (3), Tᵢₙ, Tₒᵤₜ, Pᵢₙ, and Pₒᵤₜ represent the inlet water temperature, the return water temperature, an inlet water pressure, and a return water pressure of the liquid cooling unit, respectively.

The SOC of the battery may be expressed as:

$$S = [ S O {C}_{1} , S O {C}_{2} , … , S O {C}_{k} ] \qquad ( 4 )$$

In equation (4), SOCᵢ represents an overall SOC in the i-th battery pack, and k represents the number of the battery packs in the battery box.

The ambient temperature may be expressed as:

$${T}_{E} = [ {T}_{E}^{n o w} , {T}_{E}^{next} ] \qquad ( 5 )$$

The ambient temperature includes an ambient temperature in a current time period and an ambient temperature in a next time period. In equation (5), T_{E}^{now} represents the ambient temperature in the current time period, and T_{E}^{next} represents the ambient temperature in the next time period.

The charging-discharging current may be expressed as:

$$I = [ {I}^{n o w} , {I}^{next} ] \qquad ( 6 )$$

The charging-discharging current includes the charging-discharging current in the current time period and the charging-discharging current in the next time period. A positive charging-discharging current indicates a charging state, and a negative charging-discharging current indicates a discharging state. The charging-discharging current is equal to zero, which indicates an idle state, that is, the battery box does not operate. In equation (6), I^{now} represents the charging-discharging current in the current time period and I^{next} represents the charging-discharging current in the next time period.

Based on the above, the overall state observation space is expressed as:

$$S ( t ) = \{ T ( t ) , P ( t ) , W ( t ) , S O C ( t ) , {T}_{E} ( t ) , I ( t ) \} \qquad ( 7 )$$

The action space includes but is not limited to a control mode of the liquid cooling unit, the rotation speed of the water pump, and the coolant outlet temperature.

The control mode includes but is not limited to the stopping mode, the cooling mode, the heating mode, and the pump circulation mode. The cooling mode is for the compressor, and the heating mode is for the heater.

The action space may be expressed as:

$$A = \{ {a}_{1} , {a}_{2} , … , {a}_{n} \} \qquad ( 8 )$$

In equation (8), n represents the number of agents, aᵢ represents an action controlled by an i-th agent, and the action space is not limited to discrete variables or continuous variables.

The constraint space includes but is not limited to a temperature constraint, an SOC constraint, and an ambient temperature constraint.

The temperature constraint may be expressed as:

$$T min \leq {T}_{i}^{min} \leq {T}_{i}^{max} \leq T max \qquad ( 9 )$$

The SOC constraint may be expressed as:

$$RHF min \leq {RHF}_{i}^{min} \leq R H {F}_{i}^{max} \leq RHF max \qquad ( 10 )$$

The ambient temperature constraint may be expressed as:

$${T}_{E} min \leq {T}_{E} \leq {T}_{E} max \qquad ( 11 )$$

It should be noted that the constraint space further includes a power balance constraint and a pressure constraint of the liquid cooling unit, a rotation speed constraint of the water pump, and the like.

The reward function includes a main reward function and an auxiliary reward function.

The main reward function includes but is not limited to a temperature difference of the battery box and a power consumption of the liquid cooling unit.

The temperature difference of the battery box may be expressed as:

$${F}_{Δ T} = {T}^{max} - {T}^{min} \qquad ( 12 )$$

$${T}^{max} = max \{ {T}_{1}^{max} , {T}_{2}^{max} , … , {T}_{k}^{max} \} \qquad ( 13 )$$

$${T}^{min} = min \{ {T}_{1}^{min} , {T}_{2}^{min} , … , {T}_{k}^{min} \} \qquad ( 14 )$$

The power consumption of the liquid cooling unit may be expressed as:

$${F}_{PC} = P C ( Heater ) + P C ( circulation pump ) + P C ( plate heat exchanger ) + P C ( compressor ) + P C ( air - water exchanger ) + P C ( other cooling components ) . \qquad ( 15 )$$

In equation (15), PC represents a power consumption of each component in the liquid cooling unit in a time period.

The auxiliary reward function may be expressed as:

$${F}_{T} = α f ( {T}^{max} , {T}^{min} ) + β f ( {T}^{a v g} , {T}^{s e t} ) + λ f ( RH {F}^{max} , RH {F}^{min} ) \qquad ( 16 )$$

In equation (16), n represents the number of battery cells in the battery pack, k represents the number of the battery packs in the battery box, α, β and γ represent scale factors for regulating a proportion of influences of a temperature difference and a temperature rise rate, and T^{set} represents an optimal temperature of the battery and is generally set to a room temperature of 25° C.

All the agents share one reward function Reward as:

$$R ( t ) = - γ ( {F}_{Δ T} ( t ) + {F}_{T} ( t ) + {F}_{P C} ( t ) ) \qquad ( 17 )$$

In an implementation of step S202, the state observation space, the action space of the multi-agent reinforcement learning model are determined based on the state parameter and the control parameter acquired from the energy storage system, various constraints are determined based on a heat generation model of the battery box and the cooling system, and the constraint space is determined based on the constraints. In addition, the reward function for the thermal management system is designed. Specifically, an objective function, the auxiliary reward function and a penalty function for the thermal management system are designed.

It should be noted that the objective function includes uniformity of the temperature of the battery pack and an auxiliary power consumption of the liquid cooling unit.

It should be noted that the heat generation model of the battery box may be constructed based on parameter information of the battery itself through multiple simulation experiments, or may be constructed through a neural network. The heat generation model of the battery box is not limited in the present disclosure, and any suitable heat generation model of the battery box falls within the protection scope of the present disclosure.

In step S203, the multi-agent reinforcement learning model is constructed based on the state observation space, the action space, the constraint space, and the reward function.

In an implementation of step S203, an interaction model for an agent (that is, the intelligent battery thermal management unit) and an environmental state (of the battery box and the cooling system) is constructed to obtain data for the reinforcement learning. The multi-agent reinforcement learning model is constructed based on the state observation space, the action space, the constraint space, and the reward function.

It should be noted that the multi-agent reinforcement learning model is constructed as a control unit of the intelligent battery thermal management unit for subsequent thermal management.

In step S204, state observation data at a time instant t is received and inputted into the multi-agent reinforcement learning model for training, to output an action a(t+1), a reward r(t), and a state s(t+1) at a time instant t+1.

In an implementation of step S204, the intelligent battery thermal management unit receives the state observation data at the time instant t, and inputs the state observation data into the multi-agent reinforcement learning model to train the multi-agent reinforcement learning model by using the state observation data, so as to output the action a(t+1), the reward r(t), and the state s(t+1) at the time instant t+1. In practice, the control mode of the cooling system, the rotation speed of the water pump, the water outlet temperature, and the like are outputted.

In step S205, a state value function and a dominance function are calculated based on the action a(t+1), the reward r(t), and the state s(t+1).

In step S206, a sequence formed by the action a(t+1), the reward r(t), the state s(t+1), the state value function, and the dominance function is stored in a data buffer pool.

In step S207, N sequences are sampled randomly from the data buffer pool as training data.

N in step S207 is a positive integer.

In an implementation of step S207, several sequences in the data buffer pool are sampled randomly as a small batch of samples, and the sequences are inputted into the neural network in the multi-agent reinforcement learning model.

It should be noted that a set of sequences in each iteration update is selected in an order that is different from an order in which the set of sequences is placed (in the data buffer pool), in order to reduce correlation between the sequences.

In step S208, a parameter gradient of the neural network in the multi-agent reinforcement learning model is calculated based on the sampled batch of sequences.

In step S209, a parameter of the neural network in the multi-agent reinforcement learning model is updated by using the parameter gradient of the neural network.

In an embodiment, after the parameter of the neural network in the multi-agent reinforcement learning model is updated by using the parameter gradient of the neural network, the method further includes the following operations.

A sequence formed by a current state, a current action, a current reward, a next state, the state value function, and the dominance function is stored in the data buffer pool, a preset quantity of batch of sequences is selected randomly to train the multi-agent reinforcement learning model, and the neural network in the multi-agent reinforcement learning model is updated by using the state observation data, until the multi-agent reinforcement learning model converges.

Based on steps S204 to S209, it can be understood that the observation data at the time instant t is inputted into the neural network based on multi-agent reinforcement learning, to generate the action a(t+1), the reward r(t), and the state s(t+1), and the value function and the dominance function are calculated based on the action a(t+1), the reward r(t), and the state s(t+1). The action a(t+1), the reward r(t), the state s(t+1), the state value function, and the dominance function are stored in the data buffer pool, sequences are sampled randomly, and the parameter gradient of the neural network is calculated and updated by using the sequences. The parameter of the neural network is updated and iteratively optimized based on the parameter gradient of the neural network. Based on such update strategy, the neural network is continuously updated by using the observation data until the multi-agent reinforcement learning model converges.

In step S210, it is determined whether the multi-agent reinforcement learning model converges or meets a termination condition. The process terminates in a case that the multi-agent reinforcement learning model converges or meets the termination condition. The process proceeds to step S204 in a case that the multi-agent reinforcement learning model does not converge or meet the termination condition.

Based on the above principles of the present disclosure, multiple control parameters such as the control mode of the liquid cooling unit, the rotation speed of the water pump, the inlet temperature and the outlet temperature continuously interact with the state of the battery box (including the SOC of the battery, the cell temperature, the charging-discharging current in the current time period, the charging-discharging current in the next time period, the ambient temperature in the current time period, and the ambient temperature in the next time period) and the power consumption of the liquid cooling unit. The objective function includes the uniformity of the temperature of the battery pack and the auxiliary power consumption of the liquid cooling unit, so that an optimal control action of the liquid cooling unit can be learned by maximizing a cumulative delayed reward based on a trial-and-error mechanism of multi-agent reinforcement learning. Moreover, influences of the ambient temperature and the SOC of the battery are considered, the issue of the temperature hysteresis effect is solved by using cumulative returns of reinforcement learning, so that such control strategy does not rely on human experience, thereby flexibly controlling the thermal management system, and reducing an impact of the temperature hysteresis effect of the battery box.

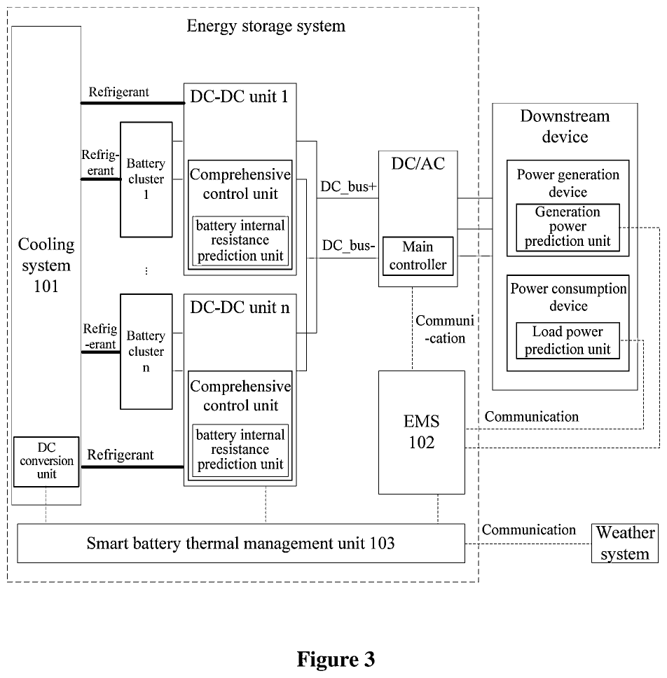

Corresponding to the thermal management method for an energy storage system according to the embodiment of the present disclosure as shown in FIG. 1, an energy storage system is further provided according to an embodiment of the present disclosure. As shown in FIG. 3, the energy storage system includes a cooling system 101, a battery system, an electric energy conversion unit, an EMS 102, and an intelligent battery thermal management unit 103.

The battery system includes a battery cluster 1 to a battery cluster n.

In an embodiment, the EMS 102 is communicatively connected to the electric energy conversion unit 305 via an end of the EMS 102, and is communicatively connected to a downstream device of the energy storage system via another end of the EMS 102.

In an embodiment, the EMS 102 is configured to receive a predicted power transmitted from the downstream device and determine a charging-discharging current of the battery system in a next preset time period based on the predicted power.

The predicted power includes a predicted electricity generation power and a predicted load power.

It should be noted that the downstream device of the energy storage system is a device that is configured to acquire electricity from the energy storage system and is arranged at an energy output port of the energy storage system, such as an energy storage converter. The downstream device of the energy storage system is not limited in the present disclosure, and any suitable device falls within the protection scope of the present disclosure.

In practice, the downstream device of the energy storage system is connected to the electric energy conversion unit. The downstream device of the energy storage system acquires electricity from the electric energy conversion unit.

In an embodiment, the intelligent battery thermal management unit 103 is communicatively connected to the cooling system 101, the electric energy conversion unit, the EMS 102, and a weather system.

In an embodiment, the intelligent battery thermal management unit 103 is configured to perform the thermal management method for an energy storage system according to any one of the embodiments described above.

It should be noted that the weather system may be a local weather system. Weather prediction information, such as an ambient temperature and humidity at a next time instant is acquired via the weather system.

In an embodiment, as shown in FIG. 3, the electric energy conversion unit includes a direct current (DC)-alternating current (AC) unit and multiple DC-DC units.

In an embodiment, a direct current side of the DC-AC unit is connected to the multiple DC-DC units via a direct current bus.

That is, the electric energy conversion unit includes the DC-AC unit and the multiple DC-DC units (such as a DC-DC unit 1 to a DC-DC unit n as shown in FIG. 3). The multiple DC-DC units each are connected to the direct current side of the DC-AC unit via a positive end DC_bus+ and a negative end DC_bus− of the direct current bus.

The DC-AC unit is communicatively connected to the EMS 102 via a communication side of the DC-AC unit. The multiple DC-DC units each are communicatively connected to the intelligent battery thermal management unit 103.

In an embodiment, each of the multiple DC-DC units is communicatively connected to the intelligent battery thermal management unit 103 via a battery internal resistance prediction unit in a comprehensive control unit in the DC-DC unit. The battery internal resistance prediction unit is configured to predict a battery internal resistance of a battery cluster connected to the DC-DC unit.

Reference is made to FIG. 4, which is a schematic diagram of a cooling circulation of a cooling system in an energy storage system according to an embodiment of the present disclosure.

As shown in FIG. 4, in a case that the cooling system 101 is a coolant system and is configured to perform thermal management on the battery system, the cooling system 101 includes a cell liquid cooling plate, a plate heat exchanger, a compressor, a condenser, an air-water exchanger, a first heater, a first circulation pump and a first electromagnetic three-way valve.

In an embodiment, a first end of the cell liquid cooling plate is connected to a first input end of the plate heat exchanger, and a first output end of the plate heat exchanger is connected to a first end C of the first electromagnetic three-way valve.

A second end A of the first electromagnetic three-way valve is connected to a second end of the cell liquid cooling plate through the first circulation pump and the first heater sequentially.

A third end B of the first electromagnetic three-way valve is connected to a second end of the air-water exchanger, and a first end of the air-water exchanger is connected to the first input end of the plate heat exchanger.

A second output end of the plate heat exchanger is connected to a second input end of the plate heat exchanger through the condenser and the compressor sequentially.

It should be noted that for the plate heat exchanger, the first input end corresponds to the first output end, and the second input end corresponds to the second output end.

It should be further noted that for the air-water exchanger, the first end corresponds to the second end.

As shown in FIG. 3 and FIG. 4, in a case that the cooling system 101 is the coolant system and performs thermal management only on the battery system, the cooling system may perform the thermal management on the battery system in the energy storage system through an internal circulation of a coolant, an external circulation of a coolant, or a circulation of a cooling agent.

In the internal circulation of the coolant, the coolant flows through the cell liquid cooling plate, the plate heat exchanger, the first electromagnetic three-way valve, the first circulation pump, and the first heater.

In the external circulation of the coolant, the coolant flows through the cell liquid cooling plate, the air-water exchanger, the first electromagnetic three-way valve, the first circulation pump, and the first heater.

In the circulation of the cooling agent, the cooling agent flows through the plate heat exchanger, the condenser, and the compressor.

With the thermal management method for the cooling system as described above, the intelligent battery thermal management unit 103 is configured to control the cooling system to perform the thermal management on the battery system in the energy storage system as follows.

The first end and the second end of the first electromagnetic three-way valve are opened, to control the battery system to be in the internal circulation of the coolant, and an operating frequency of the first circulation pump is controlled. Alternatively, the third end and the second end of the first electromagnetic three-way valve are opened, to control the battery system to be in the external circulation of the coolant, and an operating frequency of the first circulation pump is controlled. The first heater is controlled to be started or stopped. The first circulation pump and the compressor are controlled to be started and stopped, and an operating frequency of the first circulation pump and an operating frequency of the compressor are controlled.

In an embodiment, in addition to performing thermal management on the battery system, the cooling system in FIG. 3 is further configured to perform thermal management on the electric energy conversion unit. As shown in FIG. 4 and FIG. 5, the cooling system further includes a second heater, a second circulation pump, and a second electromagnetic three-way valve.

A third end of the air-water exchanger is connected to a first end C of the second electromagnetic three-way valve and a first end of the electric energy conversion unit.

A fourth end of the air-water exchanger is connected to a second end A of the second electromagnetic three-way valve.

A third end B of the second electromagnetic three-way valve is connected to a second end of the electric energy conversion unit through the second circulation pump and the second heater sequentially.

It should be noted that for the air-water exchanger, the third end corresponds to the fourth end.

As shown FIG. 5, the cooling system 101 is the coolant system and is configured to perform thermal management on both the battery system and the electric energy conversion unit in the energy storage system. The cooling system performs thermal management on the electric energy conversion unit through an internal circulation of a coolant. In the internal circulation of the coolant, the coolant flows through the second electromagnetic three-way valve, the second circulation pump, the second heater, and the electric energy conversion unit. The cooling system performs thermal management on the electric energy conversion unit through an external circulation of a coolant. In the external circulation of the coolant, the coolant flows through the air-water exchanger, the second electromagnetic three-way valve, the second circulation pump, the second heater, and the electric energy conversion unit.

Based on the energy storage system according to the embodiments of the present disclosure, the intelligent battery thermal management unit performs thermal management method for the energy storage system described above. After the multi-agent reinforcement learning model is loaded, reinforcement learning and reasoning is performed on the received state observation data by using the multi-agent reinforcement learning model, and the control action information instruction is generated based on the acquired multi-control action information and is transmitted to the cooling system in the energy storage system, so that the cooling system performs the thermal management on the energy storage system in response to the control action information instruction, thereby reducing the impact of the temperature hysteresis effect generated during the thermal management, and flexibly controlling the thermal management system.

The embodiments in the present disclosure are described in a progressive manner, and each of the embodiments focuses on its differences from the other embodiments. The same or similar parts among the embodiments may be referred to each other. The device disclosed in the embodiments corresponds to the method disclosed in the embodiments, and therefore is described in a relatively simple manner. Reference may be made to the description of the method for relevant details of the device.

Those skilled in the art may further understand that, units and algorithm steps described in conjunction with the embodiments disclosed herein may be implemented by electronic hardware, computer software or a combination thereof. In order to clearly describe interchangeability of the hardware and the software, the units and steps in each embodiment are generally described above based on functions. Whether the functions are implemented by the hardware or the software depends on a specific application of the technical solutions and a design constraint. For each of the specific applications, those skilled in the art may select a specific implementation to realize the functions described above, and the implementation should fall within the scope of the present disclosure.

In the present disclosure, the relationship terms such as “first” and “second” are only used to distinguish one entity or operation from another entity or operation, rather than to necessitate or imply that an actual relationship or order exists between the entities or operations. Moreover, terms such as “include”, “comprise” or any other variants thereof are intended to be non-exclusive. Therefore, a process, method, article or device including a series of elements includes not only the elements but also other elements that are not clearly enumerated, or further includes elements inherent to the process, method, article or device. Unless expressively limited otherwise, the statement “comprising (including) one . . . ” does not exclude existence of other similar elements in the process, method, article or device.

Based on the above description of the disclosed embodiments, those skilled in the art can implement or carry out the present disclosure. It is apparent for those skilled in the art to make many modifications to these embodiments. The general principle defined herein may be applied to other embodiments without departing from the spirit or scope of the present disclosure. Therefore, the present disclosure is not limited to the embodiments illustrated herein, but should be defined by the widest scope consistent with the principle and novel features disclosed herein.

1. A thermal management method for an energy storage system, applied to an intelligent battery thermal management unit in the energy storage system,
wherein the thermal management method comprises:
loading a multi-agent reinforcement learning model pre-trained and optimized through a simulation environment;
receiving state observation data at a current time instant;
inputting the state observation data into the multi-agent reinforcement learning model for reinforcement learning and reasoning to output multi-control action information; and
generating a control action information instruction based on the multi-control action information, transmitting the control action information instruction to a cooling system in the energy storage system, and performing, by the cooling system, thermal management on the energy storage system in response to the control action information instruction.

2. The thermal management method according to claim 1, wherein after the receiving state observation data at a current time instant, the thermal management method further comprises:
determining an observation time step of the state observation data;
determining whether the observation time step reaches a preset length;
acquiring historical observation data, iteratively training the multi-agent reinforcement learning model by using the historical observation data and updating a parameter of the multi-agent reinforcement learning model in a case that the observation time step reaches the preset length, or, continuing to the process of receiving state observation data at a current time instant in a case that the observation time step does not reach the preset length.

3. The thermal management method according to claim 1, wherein the performing, by the cooling system, thermal management on the energy storage system comprises:
performing, by the cooling system, the thermal management on a battery system in the energy storage system; or
performing, by the cooling system, the thermal management on a battery system and an electric energy conversion unit in the energy storage system.

4. The thermal management method according to claim 1, wherein the multi-agent reinforcement learning model is pre-trained and optimized by:
acquiring a state parameter and a control parameter of the energy storage system;
determining a state observation space, an action space, a constraint space and a reward function of the multi-agent reinforcement learning model based on the state parameter and the control parameter;
constructing the multi-agent reinforcement learning model based on the state observation space, the action space, the constraint space and the reward function;
receiving state observation data at a time instant t, inputting the state observation data into the multi-agent reinforcement learning model for training, to output an action a(t+1), a reward r(t) and a state s(t+1) at a time instant t+1;
calculating a state value function and a dominance function based on the action a(t+1), the reward r(t) and the state s(t+1);
storing, in a data buffer pool, a sequence formed by the action a(t+1), the reward r(t), the state s(t+1), the state value function and the dominance function;
sampling N sequences randomly from the data buffer pool as training data, wherein N is a positive integer;
calculating, based on the sampled batch of sequences, a parameter gradient of a neural network in the multi-agent reinforcement learning model; and
updating a parameter of the neural network in the multi-agent reinforcement learning model by using the parameter gradient of the neural network.

5. The thermal management method according to claim 4, further comprising:
storing, in the data buffer pool, a sequence formed by a current state, a current action, a current reward, a next state, the state value function and the dominance function; and
selecting a preset quantity of batch of sequences randomly to train the multi-agent reinforcement learning model, and updating the neural network in the multi-agent reinforcement learning model by using the state observation data, until the multi-agent reinforcement learning model converges.

6. The thermal management method according to claim 4, wherein the acquiring a state parameter and a control parameter of the energy storage system comprises:
acquiring, via an energy management system (EMS) in the energy storage system, a charging-discharging current and an ambient temperature of a battery system in the energy storage system in a current time period, and a charging-discharging current and an ambient temperature of the battery system in the energy storage system in a next time period;
acquiring a current cell state parameter of the battery system and power consumption of various components and a refrigerant returning temperature of the cooling system in the energy storage system, wherein the current cell state parameter comprises a current cell temperature and a current state of charge (SOC); and
acquiring a control parameter of the cooling system, wherein the control parameter comprises a control mode of the cooling system, a rotation speed of a water pump and a coolant outlet temperature.

7. An energy storage system, comprising:
a cooling system;
a battery system;
an electric energy conversion unit;
an energy management system (EMS); and
an intelligent battery thermal management unit, wherein
the EMS is communicatively connected to the electric energy conversion unit via an end of the EMS and is communicatively connected to a downstream device of the energy storage system via another end of the EMS, and is configured to receive a predicted power transmitted from the downstream device, and determine a charging-discharging current of the battery system in a next preset time period based on the predicted power, and the predicted power comprises a predicted electricity generation power and a predicted load power; and
the intelligent battery thermal management unit is communicatively connected to the cooling system, the electric energy conversion unit, the EMS and a weather system, and the intelligent battery thermal management unit is configured to perform the thermal management method for an energy storage system according to claim 1.

8. The energy storage system according to claim 7, wherein the electric energy conversion unit comprises a direct current (DC)-alternating current (AC) unit and a plurality of DC-DC units;
a direct current side of the DC-AC unit is connected to the plurality of DC-DC units via a direct current bus;
the DC-AC unit is communicatively connected to the EMS via a communication side of the DC-AC unit; and
the plurality of DC-DC units each are communicatively connected to the intelligent battery thermal management unit.

9. The energy storage system according to claim 7, wherein the cooling system is a coolant system and is configured to perform thermal management on the battery system, wherein the cooling system comprises a cell liquid cooling plate, a plate heat exchanger, a compressor, a condenser, an air-water exchanger, a first heater, a first circulation pump and a first electromagnetic three-way valve;
a first end of the cell liquid cooling plate is connected to a first input end of the plate heat exchanger, and a first output end of the plate heat exchanger is connected to a first end of the first electromagnetic three-way valve;
a second end of the first electromagnetic three-way valve is connected to a second end of the cell liquid cooling plate through the first circulation pump and the first heater sequentially;
a third end of the first electromagnetic three-way valve is connected to a second end of the air-water exchanger, and a first end of the air-water exchanger is connected to the first input end of the plate heat exchanger; and
a second output end of the plate heat exchanger is connected to a second input end of the plate heat exchanger through the condenser and the compressor sequentially.

10. The energy storage system according to claim 9, wherein
in an internal circulation of a coolant, the coolant flows through the cell liquid cooling plate, the plate heat exchanger, the first electromagnetic three-way valve, the first circulation pump and the first heater;
in an external circulation of a coolant, the coolant flows through the cell liquid cooling plate, the air-water exchanger, the first electromagnetic three-way valve, the first circulation pump and the first heater; and
in a circulation of a cooling agent, the cooling agent flows through the plate heat exchanger, the compressor and the condenser.

11. The energy storage system according to claim 10, wherein the intelligent battery thermal management unit is configured to control the cooling system to perform thermal management on the energy storage system by:
opening the first end and the second end of the first electromagnetic three-way valve, to control the battery system to be in the internal circulation of the coolant, and controlling an operating frequency of the first circulation pump; or opening the third end and the second end of the first electromagnetic three-way valve, to control the battery system to be in the external circulation of the coolant, and controlling an operating frequency of the first circulation pump;
controlling the first heater to be started or stopped; and
controlling the first circulation pump and the compressor to be started or stopped, and controlling the operating frequency of the first circulation pump and an operating frequency of the compressor.

12. The energy storage system according to claim 9, wherein the cooling system is further configured to perform thermal management on the electric energy conversion unit, and the cooling system further comprises a second heater, a second circulation pump and a second electromagnetic three-way valve;
a third end of the air-water exchanger is connected to a first end of the second electromagnetic three-way valve and a first end of the electric energy conversion unit;
a fourth end of the air-water exchanger is connected to a second end of the second electromagnetic three-way valve; and
a third end of the second electromagnetic three-way valve is connected to a second end of the electric energy conversion unit through the second circulation pump and the second heater sequentially.

13. The energy storage system according to claim 12, wherein
the cooling system is configured to perform thermal management on the electric energy conversion unit through an internal circulation of a coolant, wherein in the internal circulation of the coolant, the coolant flows through the second electromagnetic three-way valve, the second circulation pump, the second heater and the electric energy conversion unit; and
the cooling system is configured to perform thermal management on the electric energy conversion unit through an external circulation of a coolant, wherein in the external circulation of the coolant, the coolant flows through the air-water exchanger, the second electromagnetic three-way valve, the second circulation pump, the second heater and the electric energy conversion unit.
